(19) United States
(12) Patent Application Publication
(10) Pub. No.: US 2026/0225315 A1
(43) Pub. Date: Aug. 6, 2026

(54) BUILD MATERIAL SUPPLY SYSTEMS FOR APPARATUS FOR THE LAYERWISE MANUFACTURE OF 3D OBJECTS AND METHOD OF BUILD MATERIAL TRANSPORT

(71) Applicant: Stratasys Powder Production Ltd., Nottingham (GB)

(72) Inventors: Frederik Walsted TJELLESEN, Nottingham (GB); Anders HARTMANN, Nottingham (GB)

(21) Appl. No.: 19/150,469

(22) PCT Filed: Jan. 24, 2024
(86) PCT No.: PCT/GB2024/050185

§ 371 Date: Jul. 23, 2025

(30) Foreign Application Priority Data
Jan. 25, 2023 (GB) 2301060.6

(51) Int. Cl. B29C 64/321; B29C 64/153; B29C 64/343; B29C 64/357; B29C 64/393; B33Y 10/00; B33Y 30/00; B33Y 40/00; B33Y 50/02

(52) U.S. Cl. CPC B29C 64/321; B29C 64/153; B29C 64/343; B29C 64/357; B29C 64/393; B33Y 10/00; B33Y 30/00; B33Y 40/00; B33Y 50/02

(57) ABSTRACT

A build material supply system for the layerwise manufacture of 3D objects. The system includes a dosing device to supply build material to a work surface; a buffer tank to mix build material; an excess return chamber for receiving excess build material from a distribution device; a supply tank for holding fresh build material; a first pump and a second pump; and a controller. The first pump is coupled to the supply tank, the excess return chamber and an inlet of the buffer tank. The second pump is coupled to the buffer tank and the dosing device. The controller is coupled to the first valve and to the first and second pumps to control the amount of fresh build material relative to the excess amount of build material transported into the buffer tank. A method of transporting build material through the build material systems is also provided.

### FIELD OF THE INVENTION

The present disclosure relates to a build material supply system for an apparatus for the layerwise manufacture of three-dimensional (3D) objects from build material wherein build material surplus to layer formation is recycled in situ. A method of transporting build material through the build material supply system and a controller therefor are also disclosed.

### BACKGROUND

As additive manufacturing technologies continue to evolve, ever more challenging applications require new solutions. Repeatability and reliability of the mechanical and visual quality of objects over a build process requires consistency in the properties of build material for each layer of an object to ensure that the thermal process to which the layers are subjected remains the same. A change in the property of build material due to for example ageing can affect the melting temperature of the build material and lead to overheating or underheating of the fused layers in powder bed fusion processes. In apparatus in which build material is recycled in situ, it is particularly important to maintain a consistent mixture of recycled build material to fresh build material. A further challenge is to maintain the build material in a free-flowing state before use for layer formation so as to allow reliable dosing and to ensure that a layer of uniform density and thickness can be formed. Various build material supply systems are known, such as feed bed and auger fed systems. In such systems, build material is typically not mixed nor recycled in situ, but instead is collected as waste, removed from the apparatus, reconditioned and mixed before being provided back to the apparatus for a new build process. Known apparatus apply in situ recycling by transporting build material by augers and other rotary components. However, these can be difficult to service and may not transport all types of powders well. Other apparatus applying in situ recycling use build material pumps but do not adequately manage build material from different sources. Therefore, improvements are still needed to provide build material supply systems suitable for industrial and sustainable processing of objects.

### SUMMARY

The invention is set out in the appended independent claims, while particular embodiments of the invention are set out in the appended dependent claims.

### BRIEF DESCRIPTION OF THE DRAWINGS

Reference is now directed to the drawings, in which:

FIG. 1A is a block diagram of flow paths of build material through a build material supply system according to the invention;

FIG. 1B is a variant of FIG. 1A;

FIG. 2 is a flow chart of a method of operation according to the invention;

FIG. 3 is a schematic cross-section through an apparatus comprising a build material supply system according to FIG. 1;

FIG. 4 shows a variant of the system of FIG. 3 comprising an overflow chamber;

FIG. 5A is a variant of FIG. 1A comprising an overflow return path;

FIG. 5B is a variant of FIG. 1B comprising the overflow return path;

FIG. 6A is a 3D representation of a dosing device with a bypass chamber;

FIGS. 6B and 6C are different 3D cuts through the dosing device of FIG. 6A;

FIG. 7A is a variant of FIG. 1A comprising the dosing device of FIG. 6A;

FIG. 7B is a variant of FIG. 1B comprising the dosing device of FIG. 6A;

FIG. 8 is a 3D illustration of the exterior of a buffer tank;

FIGS. 9A to 9D are 3D illustrations of an implementation of a buffer tank interior;

FIG. 10 illustrates a single pump variant of FIG. 1A;

FIG. 11A illustrates a single pump variant of FIG. 5B; and

FIG. 11B illustrates a single pump variant of FIG. 7B.

In the drawings, like elements are indicated by like reference numerals throughout.

### DETAILED DESCRIPTION

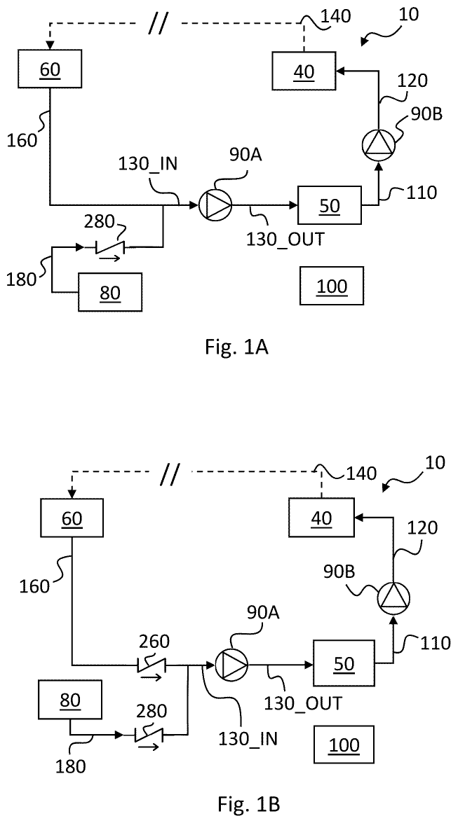

A build material supply system and a method of build material transport according to the invention, for apparatus for the layerwise manufacture of 3D objects, allowing in situ reuse of build material surplus to forming a layer, will now be described with reference to FIGS. 1 to 11B.

FIG. 1 is a block diagram illustrating the flow paths of build material through a build material supply system 10 according to the invention, in which components of the build material supply system are shown schematically in the form of blocks, and in which arrows between blocks indicate the direction of the material flow along the various paths. The various components and implementations thereof will be described further below. The build material supply system 10 comprises: a dosing device 40 configured to supply a dosed amount of build material to a work surface 8 of the apparatus, the dosed amount comprising a layer amount and an excess amount surplus to forming the layer; a buffer tank 50 configured to mix build material for supplying to the dosing device; an excess return chamber 60 for receiving excess build material from a distribution device; a supply tank 80 for holding fresh build material for replenishing the buffer tank 50; a first build material pump 90A (herein also “refill pump 90A”), and a second build material pump 90B (herein also “dosing pump 90B”), for transporting build material within the build material supply system 10; and a controller 100. An inlet of the first build material pump 90A is coupled to the supply tank 80 via a first valve 280 (also referred to herein as “supply valve 280”) and to the excess return chamber 60; and an outlet of the first build material pump 90A is coupled to an inlet of the buffer tank 50. Furthermore, an inlet of the second build material pump 90B is coupled to an outlet of the buffer tank 50 and an outlet of the second build material pump 90B is coupled to an inlet of the dosing device 40. The controller 100 is coupled to the first and second build material pump 90A, 90B, and the first valve 280, and in order to control the amount of fresh build material compared to the excess amount of build material transported into the buffer tank 50, the controller 100 is configured to (a) allow build material to flow along a supply flow path from the supply tank 80 through the first build material pump 90A and into the buffer tank 50, by controlling the first valve 280 to be at least partially open, and the first build material pump 90A to operate; (b) allow build material to flow along an excess return flow path from the excess return chamber 60 through the first pump and into the buffer tank by controlling the first pump 90A to operate, optionally while controlling the first valve 280 to at least partially close so as to restrict the flow of fresh build material over that of the excess build material. This may occur simultaneously with allowing build material to flow along a supply flow path; (c) allow build material to flow along a dosing flow path from the buffer tank 50 through the second pump 90B and into the dosing device 40, by controlling the first valve 280 to close, the first build material pump 90A to stop operating, and the second build material pump 90B to operate.

Thus, the amount of fresh build material transported into the buffer tank 50 compared to the excess amount of build material transported into the buffer tank 50 may be controlled. Furthermore, it may be ensured that the build material in the buffer tank 50 is replenished with fresh material to replace the layer amount removed from the build material supply system 10 to form a layer. The provision to two build material pumps ensures that the dosing device can be supplied with build material for reliable layer formation independently of operating the first valve, and any further valve that may be provided to control the flow of build material into the buffer tank. Operating the first valve may cause delays that lead to short feeding the dosing device and failure to distribute a complete layer.

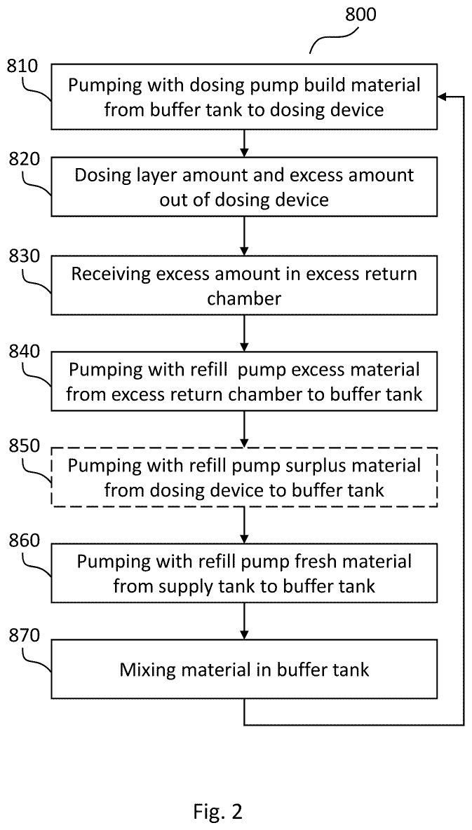

The build material supply system 10 and its variants disclosed herein are configured to provide a method of transporting build material through the build material supply system 10 for an apparatus for the layerwise manufacture of 3D objects from build material. With reference to the flow chart of FIG. 2, for a build material supply system comprising a refill pump 90A and dosing pump 90B, the method 800 comprises:
(a) at block 810, opening a dosing flow path from a buffer tank 50 to a dosing device 40, and operating the dosing build material pump 90B, to transport build material from the buffer tank 50 to the dosing device 40;
(b) at block 820, dosing a dosed amount of build material out of the dosing device, the dosed amount comprising a layer amount for providing to the work surface of the apparatus for forming a layer and an excess amount surplus to forming the layer;
(c) at block 830, receiving excess build material within the excess return chamber 60;
(d) at block 840, opening an excess return flow path and operating the refill pump to return excess build material from the excess return chamber 60 to the buffer tank 50;
(e) at block 860, opening a supply flow path from the supply tank 80 to the buffer tank 50, and operating the refill pump 90A to transport build material from the supply tank 80 to the buffer tank 50, until either a predetermined fill duration has passed or upon detecting that the level of build material in the buffer tank 50 has reached a predefined fill level; and
(f) at block 870, mixing the excess amount with the build material in the buffer tank.

The step (a) at block 810 may be repeated between steps (d) and (e). The use of build material pumps to transport build material in place of an auger and other rotating parts provides a more robust build material supply system. The components may be coupled by flexible tubing to the pumps, allowing for a compact arrangement that is easier to access and maintain than the rigid pipe arrangement required for an auger based system.

The steps (b) and (c) at blocks 820 and 830 may be repeated independently of the other steps at blocks 840 to 870. In this way, the build process of distributing layers may be timed independently from at least the steps of refilling the buffer tank at blocks 840 to 860, and mixing the material within the buffer tank at block 870 follow each step (a). Furthermore, multiple steps of dosing build material out of the dosing device at block 820 and of receiving the excess amount in the excess return chamber 60 at block 830 may be applied, optionally with a preceding step (a) of refilling the dosing chamber at block 810, to applying one instance of steps at any or all of blocks 840 to 860. The step of mixing at block 870 may be applied continuously throughout one or more of the steps at blocks 810 to 860. In some arrangements of the buffer tank, the step at block 810 may be applied only after a sequence of refilling the buffer tank at any one or more of blocks 840 to 860 and applying the step of mixing at block 870.

In the method and its variants disclosed herein, the step (a) at block 810 may comprise not operating the refill pump, for example where the refill pump, in a non-operating state, does not sufficiently close off the flow of excess build material from the excess return chamber into the buffer tank, such that operating the dosing pump 90B would cause excess build material to flow into the buffer tank 50 at block 840 simultaneous with pumping build material to the dosing device 40 at block 810. Alternatively, the buffer tank 50 may be arranged such that the excess build material may be mixed in by continuous mixing at block 870 before reaching the buffer tank outlet. For example, the excess build material may enter the buffer tank at an upper portion and build material may exit the buffer tank at an outlet arranged at a lower portion of the buffer tank.

Returning to FIG. 1A, the arrangement of the flow paths allows excess build material to be transported to the buffer tank 50 simultaneous with and alongside the fresh build material from the supply tank. This may allow the excess return chamber to be emptied even while the buffer tank is replenished with fresh build material. It may further cause the excess build material to mix with the fresh build material as it flows through the refill pump 90A and, where present, along a common outlet flow path 130_OUT between the refill pump 90A and the buffer tank 50. In arrangements where this is not sufficient to maintain the excess return chamber at a generally consistent fill level, which may cause overfilling the excess return chamber, the first valve 280 may be closed while operating the first pump 90A to further empty the excess return chamber 60. The first valve 280 may be a variable valve that is configured to open partially so as to restrict the flow of fresh build material flowing from the supply tank to the buffer tank. This may provide an improved level of control over the two flows of excess build material and fresh build material into the buffer tank. Optionally, the ratio of excess build material to fresh build material amount may be controlled by configuring the flow paths such that the flow resistance of the excess return flow path to the inlet of the first pump (or to the common inlet path 130_IN shown in FIG. 1A) is lower than the flow resistance of the supply flow path from the supply tank 80 to the first pump 90A (or to the common inlet path 130_IN shown in FIG. 1A), so that excess return build material is preferentially flowing into the buffer tank over fresh build material. This may be achieved by providing a variable first valve, for example.

FIG. 1B is a variant of FIG. 1A illustrating a second valve 260 arranged in the flow path between the excess return chamber 60 and the first build material pump 90A. This allows the excess return flow path to be closed when the supply flow path is open, thus providing improved control over the amount of excess build material transported into the buffer tank 50 compared to the amount of fresh build material from the supply tank 80. The excess return chamber 60 may thus be coupled to the refill pump via a second valve 260, and the controller 100 may be coupled to the second valve 260. To allow build material to flow along the excess return flow path, the controller may be configured to control the second valve 260 to open when controlling the refill pump 90A to operate. The controller may further be configured to control the first valve 280 to close when allowing build material to flow along the excess return flow path. The second valve may also be referred to herein as “excess return valve”.

The steps (a) to (d) at blocks 810 to 840 of FIG. 2 may be repeated one or more times, or until a predetermined duration has passed, or until detecting that the level of build material in the buffer tank and/or the excess return chamber has fallen below a respective threshold level, before proceeding to step (e) at block 860 to replenish the buffer tank with fresh build material. Not all of the steps at blocks 840 to 860 may be present in each cycle.

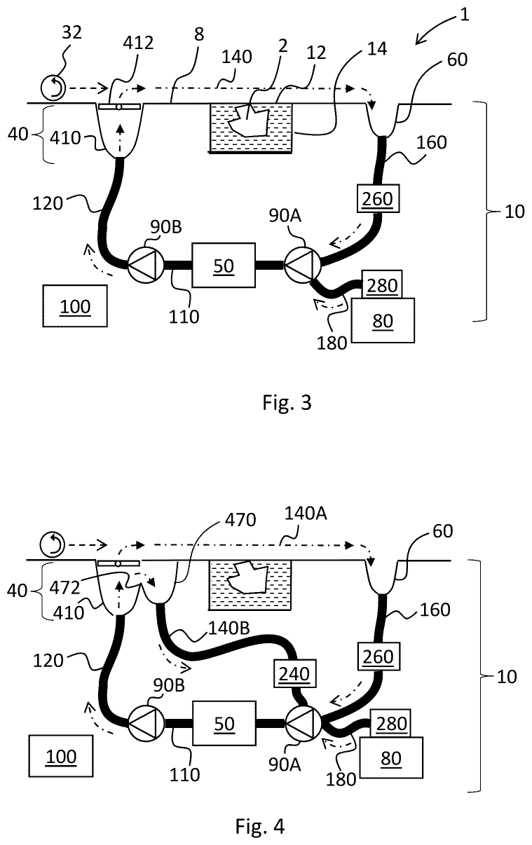

An example of a 3D printing apparatus in the form of a powder bed fusion type apparatus configured to reuse build material in situ and comprising a build material supply system according to FIG. 1B will now be described with reference to FIG. 3. FIG. 3 illustrates a schematic cross section of a material supply system 10 arranged below the work surface 8 of an apparatus for the layerwise formation of an object 2. In FIG. 3, the second valve 260 may be optional as illustrated in FIG. 1A. Build material mixed and of a composition suitable for forming layers is provided to the buffer tank 50. The dosing device 40 comprises a dosing chamber 410 provided below the work surface 8. The work surface comprises a build area 12 forming the top-most surface of a build volume 14. The build volume 14 is supported on a build platform within container walls (not shown) and comprises completed cross sections of the object 2 to be formed. The dosing device 40 comprises a dosing outlet within the work surface 8 and within which a dosing blade 412 is rotatably provided. Further provided at a side of the build area 12 opposite to that at which the dosing outlet is located is an excess return chamber 60. From the dosing chamber 410, an amount of build material is dosed to the work surface by rotating the dosing blade 412 to scoop a dosed amount of build material from within the dosing chamber 410, and to hold the dosed amount above the work surface 8. A distribution device 32, here illustrated as a roller, is moved from left to right to spread the dosed amount of build material along a distribution path 140.

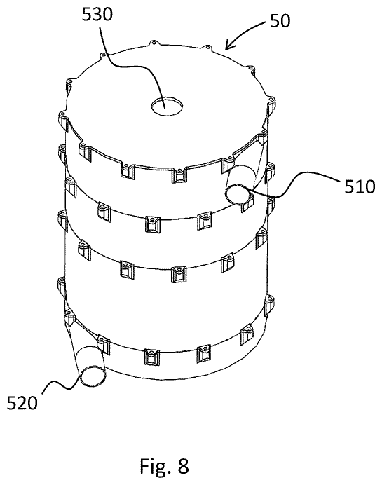

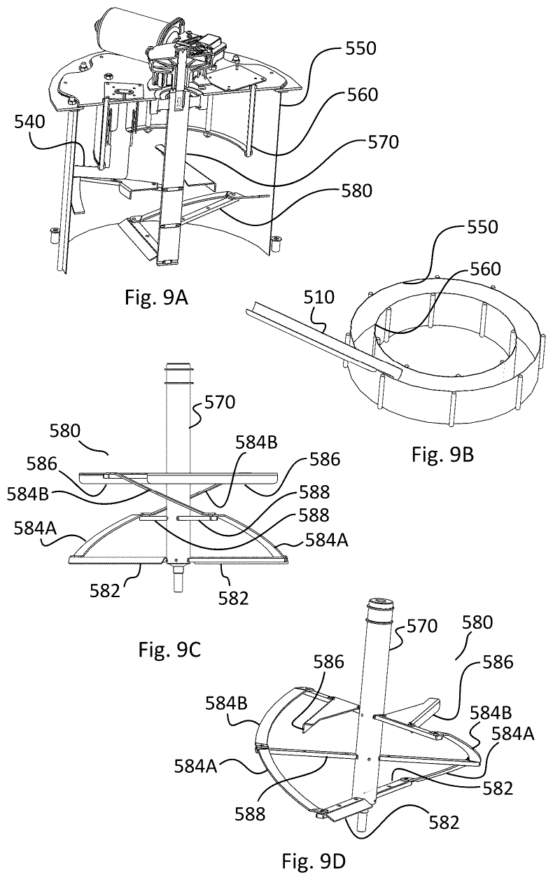

The buffer tank 50 is configured to mix the build material, intermittently or continuously, so as to keep the build material in a homogenous, and preferably free flowing, state. An example of a buffer tank will be described below with reference to FIG. 8 and FIGS. 9A-9D. The first valve 280 in the supply flow path and the optional second valve 260 in the excess return path are indicated by blocks are coupled to the refill pump 90A. The buffer tank outlet is coupled directly to the dosing chamber inlet via the dosing pump 90B. The controller 100 may control the dosing pump to operate to allow build material to flow from the buffer tank 50 to the dosing chamber 410.

The dosed amount transported along distribution path 140 by the roller 32 comprises an excess of amount of build material. The excess of amount of build material prevents short feed of build material and incomplete layer formation. The excess amount is pushed by the distribution device 32 into the excess return chamber 60 at the end of the layer formation stroke. It should be noted that the dosed amount comprising a layer amount and an excess amount surplus to forming the layer may comprise a further amount that is spread over the work surface outside of the build area, for example. The controller 100 may control the first and/or second valves to open the supply flow path along flow path portion 180 from the supply tank 80 to the refill pump 90A to allow fresh build material to flow from the supply tank through the refill pump 90A and to the buffer tank 50, and/or to open the excess return flow path along flow path portion 180 from the excess return chamber 60 to the refill pump 90A to allow excess build material to flow from the excess return chamber 60 through the refill pump 90A and to the buffer tank 50. The controller may control the flow paths to open sequentially or simultaneously. Thus, the apparatus comprising the build material supply system 10 provides for the immediate in situ reuse of excess build material during a build process of the apparatus.

A variant of the apparatus of FIG. 3 is shown in FIG. 4, in which the dosing device 40 further comprises an overflow chamber 470 connected to the dosing chamber 410 via an overflow outlet 472. The overflow outlet 472 is arranged below the level of the dosing outlet. As the dosing chamber fills with build material supplied from the dosing flow path and reaches the level of the overflow outlet 472, oversupplied build material flows through the overflow outlet 472 and into the overflow chamber 470. This arrangement of dosing device 40 allows the amount of build material in the dosing chamber to be self-regulating, or passively regulated, and ensures that a consistent amount of build material may be dosed to the work surface 8 for each layer. The build material transferred out of the dosing chamber thus comprises the dosed amount and an oversupply amount, the dosed amount flowing along a distribution path 140A towards the excess return chamber 60, and the oversupply amount along overflow return flow path 140B. All other components are as described and referenced for FIG. 4. The oversupply amount may be immediately returned to the buffer tank 50 via the overflow return flow path 140B.

The build material transport mechanism in FIG. 3 and FIG. 4 is thus provided in the form of two build material pumps 90A and 90B, which may be diaphragm pumps, and one or more valves to allow opening and shutting the flow paths described herein.

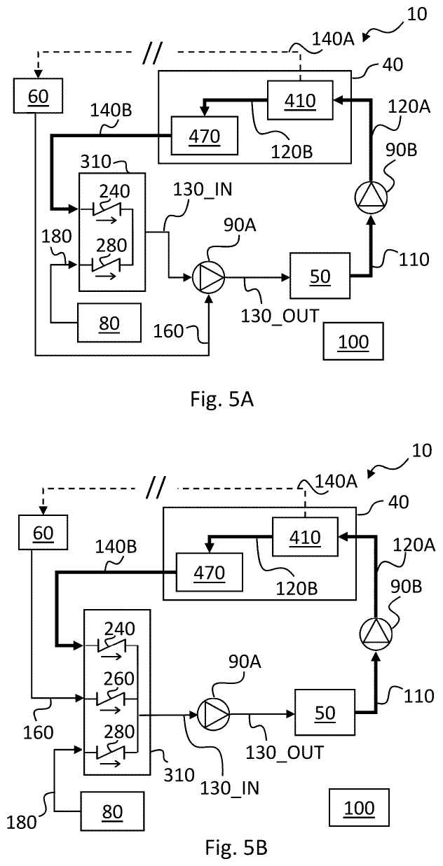

Turning next to FIG. 5A which is a variant of FIG. 1A, the flow paths of the build material supply system 10 of FIG. 4 are illustrated further in a block chart diagram, and in which the overflow valve 260 may be optional. The build material supply system 10 comprises a first group 310 of at least two valves: a supply valve 280 (first valve) between the supply tank and the refill pump 90A, and an overflow valve 240 between the overflow chamber 470 and the refill pump 90A. The dosing device comprises a dosing chamber having an inlet coupled to the outlet of the dosing pump 90A and configured to receive build material from the buffer tank 50 via the dosing pump 90A. The inlet of the dosing chamber 410 thus represents the inlet to the dosing device 40. The dosing device 40 further comprises an overflow chamber 470 coupled to an overflow outlet 472 of the dosing chamber 410 and configured to receive an oversupply amount of build material from the dosing chamber 410 when the build material in the dosing chamber reaches a predefined level. The overflow chamber 470 is coupled to the inlet of the refill pump 90B via the overflow valve 240. The controller 100 is coupled to the supply pump 90A and dosing pump 90B and is configured to control pump operation and the open and close positions of the supply valve 280, of the overflow valve 240 and, where present, of the excess return valve 260. To open the overflow return flow path 140B (and here also 130_IN), the controller 100 is configured to control the supply valve 280 to close and the overflow valve 240 to open, and the refill pump 90A to operate, to allow oversupplied build material to flow along the oversupply return flow path from the overflow chamber 470 through the refill pump 90A to the buffer tank 50. The operation of the supply valve 280 to allow the flow of fresh build material and/or of excess build material to flow to the buffer tank 50 is as described for FIG. 1A.

FIG. 5B is a variant of FIG. 5A comprising the excess return valve between the excess return chamber 60 and the refill pump 90A. As described for FIG. 4, the excess return chamber 60 is coupled to the refill pump 90A via the excess return valve 260. The controller 100 is coupled to the excess return valve 260 and is configured to control the excess return valve 260 to close when controlling the refill pump 90A to operate to allow build material to flow along the oversupply return flow path and/or the supply path. The excess return valve 260 provides for improved control over the ratio of the amount of excess build material to fresh build material and oversupply material that is allowed to flow to the buffer tank.

The supply valve 280, the overflow valve 240 and the excess return valve 260 may be individually connected to the refill pump 90A via dedicated inlet flow paths, or they may be coupled to a combined inlet flow path 130_IN as shown here. The dosing flow path may be controlled to be open by the controller causing the dosing pump 90B to operate, allowing build material to flow from the buffer tank 50 through the dosing pump 90B and into the dosing chamber 410.

The build material supply system 10 of FIGS. 5A and 5B provides a dosing device 40 for dosing build material from below the work surface to the work surface of the apparatus, and which is configured to passively regulate the level of build material within the dosing chamber. By ensuring that the level of powder remains the same within the dosing chamber 410, the dosed amount may be substantially the same for each layer. This may ensure that each dosed amount is sufficient to form a complete layer, and that the excess amount is also substantially the same. To ensure a substantially consistent ratio of excess to fresh build material transported to the buffer tank 50, a simple control may comprise opening the excess return flow path over a constant duration at constant intervals of time, compared to a respective duration period at constant intervals of time over which the supply path is open. Similarly, by transporting a substantially constant amount of build material from the buffer tank 50, for example by similarly opening the dosing flow path over a constant period at constant intervals of time, the oversupply amount may be metered with respect to the excess and fresh amount transported to the buffer tank.

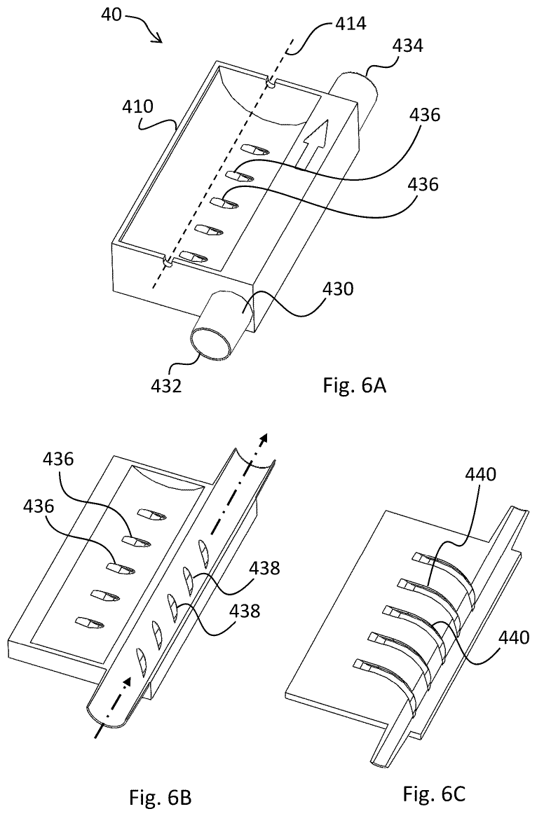

One challenge of using a build material pump to transport build material in a 3D apparatus is to reduce or prevent propelling build material into the atmosphere within a dosing device comprising a dosing chamber 410 into which build material is pumped at elevated gas pressure bursts. Furthermore, the pump may be very efficient in supplying large amounts of build material over a short duration of time, such that the amount supplied to the dosing chamber may require careful control, whether by active or passive means. A variant of a dosing device 40 comprising a bypass chamber coupled to the dosing chamber may alleviate or prevent the generation of build material dust in the dosing chamber as will now be described with reference to FIGS. 6A to 6C. FIG. 6A illustrates a 3D view of the dosing device 40 from above, in which the dosing chamber 410 is represented as an elongate trough-shaped container configured to comprise a dosing blade (not shown) to be mounted and rotatable about an axis 45. Build material is supplied to the dosing chamber interior from a plurality of inlet ports 446. Each inlet port is connected via an inlet flow path 440 to a bypass outlet port 438. As shown herein, the outlet ports 438 are arranged along the length of an intermediate section of the bypass pipe 430. Each inlet path 440 has a significantly higher flow resistance than the bypass 430; preferably the combined flow resistance of the inlets is larger than the flow resistance of the bypass pipe between its inlet and outlet. As build material is pumped from the bypass inlet 432 through the bypass, it is forced by build material flow into the multiple outlet ports 438 arranged along the length of the intermediate section, each port connected to an inlet 436. The dosing chamber inlets 436 are preferably arranged along a lower portion of the dosing chamber and such that build material enters the dosing chamber along a substantially horizontal direction, or at a tangent to the curvature of the trough, so as to avoid propelling the material into the atmosphere of the dosing chamber and into the work space above the work surface 8. From the bypass outlet 434, the build material may be circulated back into the buffer tank 50. The inlet paths 440 are illustrated in more detail in FIG. 6B and FIG. 6C, which illustrate cuts at two different depths through the dosing chamber floor to reveal the outlet ports in the bypass chamber 430 and the inlet paths 440. By selecting a suitable flow resistance for the flow paths, for example between each of an intermediate bypass outlet and a corresponding dosing chamber inlet, excessive amounts of fast flowing gas entering the dosing chamber 410 may be prevented. Instead, the gas may predominantly or entirely flow along the bypass chamber 430 and out of the bypass outlet 434.

The dosing chamber inlet paths 440 are configured to present a flow resistance to build material flow that is higher than the flow resistance of the bypass chamber 430 between the inlet and the outlet 432, 434 of the bypass chamber 430. Furthermore, the combined flow resistance of a plurality of dosing chamber inlet paths 440, each dosing chamber inlet path 440 arranged between an outlet port 438 and dosing chamber inlet 436, may be higher than the flow resistance of the bypass chamber between the inlet 432 and the outlet 434 of the bypass chamber 430. Each of the plurality of outlet ports 438 may be connected to a respective dosing chamber inlet 436. The one or more dosing chamber inlets 436 may be arranged near a gravitationally lower section of the dosing chamber 410, for example at or near the gravitational bottom of the dosing chamber 410, and/or may be arranged to provide a flow of build material into the dosing chamber at an angle having a parallel component to an inner wall of the dosing chamber. In this way, the generation of build material suspended in the atmosphere of the dosing chamber may be reduced.

Furthermore, self-regulation of the amount of build material supplied to the dosing chamber 410 may be achieved by balancing the flow path resistance between each outlet port 438 and corresponding dosing chamber inlet 436 against a fill level above the inlet level within the dosing chamber. In addition, or instead, the fill level may reach the underside of the dosing blade, which during filling may be in the horizontal position and closing off the dosing outlet to the work space. The dosing blade may be used to provide a resistive force to the flow through the dosing chamber inlets so as to block them against supplying further build material. Alternatively, as the build material inside the dosing chamber will eventually obscure the inlets 436 and increase the flow resistance beyond a maximum flow resistance, the flow through the inlet paths 440 may be caused to stop. A build material level sensor may be provided in the dosing chamber and connected to the controller so as to allow the controller to close off the dosing flow path when the sensor detects that a predefined fill level has been reached. Alternatively, the dosing chamber 410 may further comprise an overflow outlet coupled to an overflow chamber 470 as described herein with reference to FIG. 4 to FIG. 5B. Such approaches may be applied to passively regulate the amount of build material in the dosing chamber 410 to be at a predetermined fill level and thus may allow a continuous circulation of build material along the pump to dosing path 120 without overfilling the dosing chamber. Alternatively, build material may be passed through the bypass 430 intermittently to supply a predefined amount of build material to the dosing chamber over a given number of layer cycles.

Typically, the length of the dosing chamber 410 (along the rotation axis of the dosing blade) is the same as or exceeds the width of the build area 12, the width being parallel to the axis of the dosing blade and perpendicular to the direction of distribution by the distribution device. It may be beneficial that build material inside the dosing chamber 410 is evenly distributed along the length direction, such that the dosed amount dosed to the work surface is evenly distributed along the side of build area. As shown, a plurality of dosing chamber inlets 436 may be arranged along the length of the dosing chamber, which improves the even distribution of build material inside the build chamber 410.

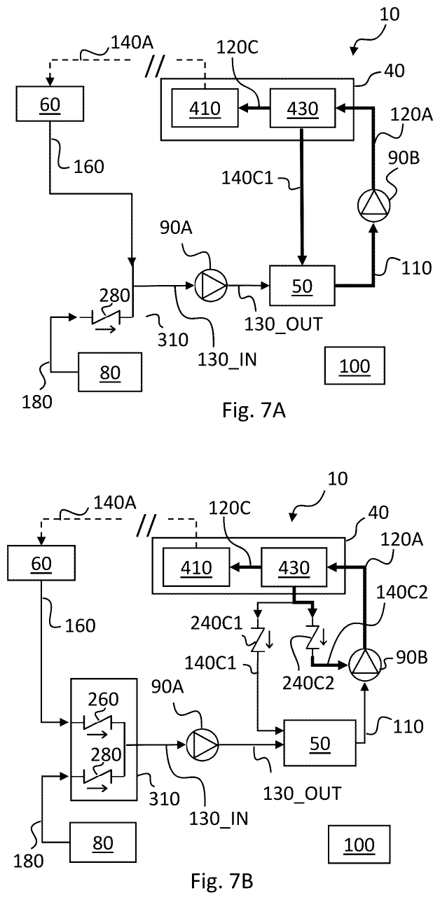

FIG. 7A illustrates a flow path through a build material supply system 10 wherein the dosing device 40 comprises a dosing chamber 410, and a bypass chamber 430 having a bypass inlet 432 and a bypass outlet 434 at either end of an intermediate section, the intermediate section comprising one or more intermediate outlets 438, wherein the bypass inlet 432 is coupled to the outlet of the dosing pump 90B and the bypass outlet 434 is coupled to the inlet of the buffer tank 50. The dosing chamber 410 comprises one or more dosing chamber inlets 436 configured to receive build material from the bypass chamber 430 and coupled to the one or more intermediate outlets 438 to form one or more intermediate flow paths 440; such that when the controller 100 controls the dosing pump 90B to operate, build material is caused to flow along the dosing flow path from the buffer tank 50 through the dosing pump to the bypass chamber 430 and along the one or more intermediate flow paths 440 to the dosing chamber 410 to supply build material from the buffer tank 50 to the dosing chamber 410, and an oversupply of build material to return along a direct oversupply return flow path 140C2 from the bypass chamber 430 to the buffer tank 50. The open dosing flow path is indicated in bold along flow path portions 110, 120A, and the open oversupply return path 140C1 in also indicated in bold.

Preferably, the one or more intermediate flow paths are configured to have a flow resistance that is substantially higher than the flow resistance from the bypass inlet to the bypass outlet, such that gas from the pump predominantly flows from the bypass inlet to the bypass outlet. In addition, or instead, the combined flow resistance of the one or more intermediate flow paths may be substantially higher than the flow resistance from the bypass inlet to the bypass outlet, such that gas from the pump predominantly flows from the bypass inlet to the bypass outlet.

In a variant of FIG. 7A, shown in FIG. 7B, the direct oversupply return flow path 140C1 may comprise a direct bypass return valve 240C1 that the controller 100 causes to be open so as to allow the oversupply amount to flow from the bypass chamber 430 along the from the bypass chamber directly to the buffer tank 50. When opening the supply path by controlling the supply valve 280 to open and/or the excess return path by causing the excess return valve 260 to open, and the refill pump 90A to operate, the controller may further control the direct bypass return valve 240C1 to shut to precent unintentional flow of oversupply build material into the buffer tank. Optionally, as shown in FIG. 7B, the bypass outlet may further be coupled to an inlet of the dosing pump 90B via a recirculation valve 240C2, wherein the controller is coupled to the recirculation valve 240C2 and is configured to, preferably in that order:
(i) allow build material to flow along the dosing flow path and oversupply build material to return along the direct oversupply return flow path from the bypass chamber 430 direct to the buffer tank 50, by controlling the recirculation valve 240C2 to close and the direct oversupply return valve 240C1 to open, and the dosing pump 90B to operate; optionally after or while controlling the supply valve 280 and, where present, the excess return valve 260, to close;
(ii) allow build material to circulate from the bypass chamber 430 through the dosing pump 90B and back to the bypass chamber 430 so as to reuse the oversupply amount of build material to fill the dosing chamber 410 by controlling the direct oversupply return valve 240C1 to close and the recirculation valve 240C2 to open, and the dosing pump 90B to operate;
(iii) control the recirculation valve 240C2 to close while keeping the direct oversupply return valve 240C1 closed, and the refill pump 90A to operate, and:
   allow excess build material to flow along the excess return path into the buffer tank 50, by controlling, where present, the excess return valve 260 to open, and optionally to control the supply valve 280 to at least partially close; and
   allow fresh build material to flow along the supply flow path into the buffer tank 50, by controlling the supply valve 280 to open; and optionally, where present, the excess return valve 260 to close.

Returning to FIG. 2, with respect to build material supply systems comprising a bypass chamber 430, an optional block 850 of the method 800, and as indicated in FIG. 2 by a dashed outline, may comprise operating the dosing pump 90B while opening the oversupply return flow path to return oversupply build material from the dosing device 40 to the buffer tank 50. This may be applied over a predefined oversupply return duration, or until the build material level in the bypass chamber 430 has fallen below a predefined minimum level.

The build material transported to the dosing device at block 810 may therefore comprise an oversupply amount of build material, the step (b) at block 820 may further comprise a step (b1) of allowing the oversupply amount to flow out of the dosing device 40 and into the buffer tank, and a step (b2) at block 850 of operating the dosing pump to return the oversupply amount to the buffer tank 50. Optionally, a recirculating flow path 140C2 may be opened sequentially from the bypass chamber 430 to the dosing pump 90B and back to the bypass chamber 430 to reuse the oversupply amount in the dosing device. The method 800 of FIG. 2 may thus comprise: wherein the dosing device comprises an overflow chamber 470 as shown in FIGS. 5A and 5B, returning the oversupply amount directly to the buffer tank 50; or, wherein the dosing device comprises a bypass chamber 430 as shown in FIGS. 7A and 7B, returning the oversupply amount to the buffer tank 50 via the overflow valve 240 and the refill pump 90A.

The step (b2) at block 850 may not be applied at each of a plurality of repeats of the cycle from blocks 810 to 850. Alternatively, block 850 may be applied over a predetermined duration shorter than that of step (d) at block 840, or upon detecting that the level of build material in the buffer tank and/or the excess return chamber has fallen below a respective predetermined level, such that excess build material is returned to the buffer tank for reuse before oversupply build material is returned to the buffer tank.

The method may comprise returning excess build material at block 840 to the buffer tank 50 first, before returning, where present, oversupply material to the buffer tank at block 850, and before transporting fresh build material from the supply tank at block 860; and wherein the step at block 860 is initiated so as to maintain the build material in the buffer tank at a substantially consistent ratio of excess to fresh build material. For example, block 860 may be initiated by the controller upon detecting that the fill level in the buffer tank 50 has reached a minimum fill level.

In the build material supply system at its variants described herein, the controller may be configured to cause the dosing pump 90B to stop operating before controlling the refill pump 90A to operate, and vice versa. This may be preferable in variants in which the oversupply flow path and the excess return flow path do not comprise a valve that enables shutting off the flow of build material to the buffer tank. It may further be preferable to shut off the refill pump when the excess return chamber or the overflow chamber is detected as being empty, and to avoid drawing hot air from the work space into the build material supply system.

### Flow Path Prioritisation

Herein, “fresh” build material may include a predefined mixture of virgin and reused material from a previous one or more build processes, for example 30:70 or 20:80 virgin: reused ratio. For most build materials, due to thermal ageing, it is preferable or required that the virgin: reuse ratio supplied to the dosing chamber does not change significantly enough during the build process so as to significantly alter the thermal properties of the build material. In a powder bed fusion process, it is important that the properties of the build material supplied to the dosing chamber and for forming each layer do not change significantly during a build process. A substantial change in the reuse content is likely to alter the thermal properties of the build material, which in turn will lead to different response of the layer of build material to the thermal cycle applied to fuse the layer. For example, the melting temperature of the build material may shift to a higher temperature than the process was calibrated for, and the thermal energy applied to fuse a cross section of the objects within that layer may not cause the same degree of fusion as for previous layers. This may result in progressive changes in mechanical and potentially visual properties of the object. Any significant departure from a reliable uniform process leads to object inconsistencies and thus reduced yield due to rejection of unsuitable objects, and this may be avoided by controlling and timing the amount of build material supplied from the various sources to the buffer tank 50.

The build material systems and method of transporting build material therethrough may be particularly beneficial in apparatus in which excess return build material may have undergone a degree of ageing and change in properties, for example in which the excess return amount is subjected to heating to near the melting temperature as it is being transferred across the work surface and build surface of the apparatus. The provision of a buffer tank 50 in addition to the supply tank 80 allows, by suitable operation of the flow paths and valves, to maintain a build material mixture with consistent properties throughput the build process by controlling the ratio of excess build material and fresh build material flowing into the buffer tank. Excess build material in the case of powder bed fusion processes experiences relatively high processing temperatures near to the melting temperature of the material, and may have undergone degradation. While the in situ reuse of excess build material increases the use rate of build material, it is important to ensure that degraded material is fed back in a manner that ensures that it does not affect the overall properties of the build material in the buffer tank 50 throughout the build process. Thus, excess build material may be fed back into the buffer tank 50 together with fresh build material from the supply tank 80 in a controlled, cyclical manner to ensure that the build material mixture within the buffer tank 50 remains substantially consistent throughout a build process. This would not be possible with a single tank. Furthermore, the buffer tank 50 is arranged to mix the build material, thus providing homogenous build material of consistent properties to the dosing device. The supply tank 80 as disclosed herein may not require mixing functionality. The step (f) at block 870 of mixing may be applied continuously throughout the disclosed blocks of the method.

To allow the excess build material to flow along the excess return flow path into the buffer tank 50, the controller 100 may control the supply valve 280 to close to shut off the supply flow path, and the first pump 90A to operate, and, where present, the excess return valve 260 to open. Alternatively, the controller 100 may be configured to control the supply valve to open, and where present the excess return valve to open simultaneously, so as to allow excess build material and fresh build material to flow simultaneously along the supply flow path and the excess return flow path.

Where the dosing device comprises an overflow chamber 470, the controller may further control the overflow return valve 240 to open to allow oversupply build material to flow from the overflow chamber into the buffer tank 50 simultaneously with the excess build material and fresh build material.

The supply flow path in the variants disclosed herein may be configured to have a higher flow resistance to build material flow than the excess return flow path. This may be achieved by restricting the diameter of the supply pipes, for example. Additionally, or instead, any one or any combination of the supply valve, the excess return valve, and the overflow or oversupply return valve 240, 240C1 may be variable valves and operated to control the amount of build material flowing into the buffer tank from the different sources, so as to maintain a consistent ratio of excess build material to fresh build material, and where present to oversupply build material. The controller may be configured to control the said variable valves so as to adjust the flow resistance to build material flow through the said valve or valves. For example, the overflow return valve 240 may be a variable valve, and the controller may be configured to control the overflow return valve 240 to be partially open, so as to apply a higher flow resistance to the flow of oversupply build material through the oversupply return flow path compared to the flow resistance to the flow of excess build material along the excess return flow path. Additionally, or instead, the supply valve 280 may be a variable valve, and the controller may be configured to control the supply valve 280 to be partially open so as to apply a higher flow resistance to the flow of fresh build material through the supply flow path compared to the flow resistance to the flow of excess build material along the excess return flow path. In build material systems having an oversupply return path, such as the overflow return path of FIGS. 5A and 5B, the controller may further be configured to control the supply valve to be partially open so as to apply a higher flow resistance to the flow of fresh build material through the supply flow path compared to the flow resistance to the flow of oversupply build material along the overflow return flow path.

With respect to build material supply systems comprising an overflow chamber 470, an optional block 850 of the method 800, and as indicated in FIG. 2 by a dashed outline, may comprise operating the build material pump while opening an oversupply return flow path to return oversupply build material from the dosing device to the buffer tank. This may be applied over a predefined overflow return duration, or until the build material level in the overflow chamber has fallen below a predefined minimum level.

Thermal ageing such as in the form of degradation or polymer chain growth may occur when build material experiences elevated temperatures, especially those near the melting point. Nylon PA11 for example has a melting temperate of around 200° C. PA11 build material within the flow paths between valves, and for example within the dosing chamber, may be brought to a temperature of 100-140° C. before being dosed to the work surface 8. As the dosed amount is distributed over the previous build area to form a new layer, it is spread onto the hot surface of the existing build volume, which may be maintained at a build bed temperature of around 180° C. The dosed amount is thus much colder than the build bed temperature, and to prevent warping and curl of the underlying fused cross sections, the new layer is typically preheated immediately to bring it up to or near to the build bed temperature. This may be done by arranging a heat bar, such as an infrared bar lamp, to follow the spreading device to preheat the new layer as it is being formed. The excess amount ahead of the spreading device will also heat up through contact with the underlying build volume and will therefore have experienced the highest thermal impact of the powder within the supply system to the buffer tank. It is generally desirable to reuse the excess build material first. Since the excess amount is typically relatively small compared to that in the buffer tank, it may be returned immediately to the buffer tank and mixed with the buffer tank build material. Meanwhile, in the case of the system of FIG. 4, the main source of build material within the buffer tank may be from the supply tank, which comprises build material with predefined properties. In the case of a system of FIG. 5, which comprises an additional flow path of the dosing overflow 470, the overflow build material may also be returned to the buffer tank 50 before build material from the supply tank 80 is required. The overflow material from the dosing overflow 470 may have had a lower thermal exposure than the excess build material and may be returned to the buffer tank after the excess material is returned to the buffer tank 50.

Herein, the excess return chamber 60, the overflow chamber 470 and the bypass chamber 430 may be configured to hold a certain amount of build material before build material from these chambers needs to be transported to the buffer tank. Therefore, it may be possible to transport build material sequentially and apply certain orders and/or flow controls. The build material supply system may provide for a method of build material transport in which the controller controls the supply valve 280 to close to shut off the supply flow path, and to control the refill pump 90A to operate, and, where present, the excess return valve 260 to open, to allow the excess build material to flow along the excess return flow path. After this, the controller may control the excess return valve 260 to close and the supply valve 280 to open to refill the buffer tank 50 with fresh build material, thus applying a sequential filling method with improved control over the amounts of excess return and fresh build material transferred into the buffer tank 50. Alternatively, the excess return build material may be returned to the buffer tank at the same time as transporting fresh build material from the supply tank to the buffer tank 50.

The controller may be configured to prioritise the flow of build material to the buffer tank while causing the refill pump 90A to operate, by applying the order of: (1) allowing excess build material to flow along the excess return path by controlling the supply valve 280 to at least partially close so as to at least partially block the flow of fresh build material from the supply tank 80 to the buffer tank 50 and controlling the refill pump 90A to operate; (2) where present, allowing oversupply build material to flow along the oversupply return path by controlling the supply valve 280 to at least partially close; where present, controlling the excess return valve 26 to at least partially close; in the overflow variant, controlling the overflow valve 240 to open; and controlling the refill pump to operate. In the bypass variant, the second step may comprise allowing oversupply build material to flow along the oversupply return path by controlling the supply valve 280 to at least partially close, and, where present, controlling the direct return valve 240C1 26 to open. Where the recirculation valve 240C2 is present the controller may further control the recirculation valve 240C2 to close; (3) allowing fresh build material to flow along the supply flow path by: controlling the supply valve 280 to open; and the overflow valve 240, or the direct return valve 240C1 and optionally where present the recirculation valve 240C2 to close; where present, the excess return valve 260, to close; and the refill pump to operate.

During each of the steps, the dosing pump may not operate. The excess return flow path and the supply flow path may be closed before opening the dosing flow path at block 810 so as to ensure that build material cannot immediately enter the dosing flow path without being mixed into the build material within the buffer tank. The dosing flow path may be closed and the supply flow path at least partially closed when opening the excess return flow path at block 840. The dosing flow path may be closed for example when opening the supply flow path at block 860. This improves the homogeneity of the build material within the buffer tank 50, however depending on how the excess and fresh build material is fed into the buffer tank, it may not be necessary to mix the added build material in before transporting build material along the dosing flow path from the buffer tank to the dosing device. For example, when build material is fed into the buffer tank at an upper section and exits into the dosing flow path at a lower section, it may not immediately reach the buffer tank outlet before being mixed with the existing material. The steps at blocks 840 and 860 may be applied simultaneously and may optionally comprise at least partially opening the respective flow paths so as to vary the flow resistances of the respective flow paths, such that excess build material flows along the excess return flow path to the buffer tank preferentially, or first, over fresh build material along the supply flow path from the supply tank 80, and so as to maintain a substantially consistent ratio of excess to fresh build material within the buffer tank.

In variants of the method, the steps at blocks 810 to 860 may be applied sequentially with each step present in each cycle. Alternatively, the step of dosing build material out of the dosing chamber at block 820 may be controlled independently from any or any combination of the remaining steps, i.e. of managing the fresh build material, excess material and where present oversupply material to the buffer tank 50 and build material from the buffer tank to the dosing device 40. In this way, the build process for an object may occurs over a fixed cycle duration and without delays due to the operation of the build material supply system. The step of receiving excess build material in the excess return chamber 60 at block 830 is dependent on block 820. Meanwhile, the block 840 of transporting excess build material along the excess return flow path, block 850, where present, of transporting oversupply build material along the overflow return path, the direct oversupply flow path or the recirculating oversupply flow path, and/or the block 860 of transporting fresh build material along the supply flow path may be controlled independently from the blocks 810 and 820. These blocks may be applied sequentially and/or over fewer cycles compared to the number of dosing cycles at block 810. Additionally, block 860 may be applied after repeating the step at blocks 840 and, where present, at block 850. At block 860, the fresh build material is transported to refill the buffer tank and to replace the amount lost to forming the layers. Furthermore, the controller may be configured to prioritise the reuse of excess return material over that of fresh build material and/or to control the dosing of the dosed amount from the dosing device. The buffer tank 50 may comprise a sensor configured to detect a fill level of build material within the buffer tank 50, and the controller may be configured to receive the sensed fill level from the sensor and to open the supply flow path upon determining that the sensed build material level is below a predetermined threshold level.

The durations over which each flow path is to be open may be predefined or dynamically controlled based on measurements of the build material level comprised within the various chambers and tanks. The measurements may be provided by one or more build material level sensors, or mass sensors, arranged within and configured to measure the amount of build material in the buffer tank 50, and optionally further in one or more of the excess return chamber, the dosing chamber and, where present, the overflow chamber. The controller 100 may be configured to receive data from a build material level sensor, or a mass sensor, configured to measure the amount of build material in the buffer tank 50. Based on the measured amount, the controller 100 may control the timings and durations of transporting excess build material, overflow build material and fresh build material into the buffer tank 50. For example, the timing of transporting build material from the various sources to the buffer tank may be adjusted during the build process in response to the measured amount of build material in the buffer tank.

For each layer formed, a deficit amount of build material may be the amount used for forming a layer over the work surface 8 and build area 12 over a layer cycle. The excess amount may be significantly smaller than the deficit amount of each layer cycle. A relatively larger mount of overflow build material may be generated compared to the excess amount. The controller may control the supply flow path, the excess return path and the oversupply flow path such that only excess and oversupply build material are returned alternately one or more times to the buffer tank 50 before opening the supply flow path to allow fresh build material from the supply tank to flow to the buffer tank. To reduce the duration over which the build material entering the buffer tank requires to be mixed into the existing amount of build material, alternatively, a supply cycle may comprise multiple instances, at fixed or variable durations, over which overflow material to be transported into the buffer tank, while there may only be one instance, or fewer than the multiple instances, over which excess material and/or fresh build material is transported into the buffer tank 50.

In a variant of the method, blocks 810 and 820 may be applied for each cycle. Blocks 840 and 860 may be applied alternately, each at every second cycle. Where block 850 is present, the three blocks may alternate over the cycles, such that each block is applied every third cycle. The controller may be configured to:
Cycle 1: open the dosing flow path to fill the dosing chamber; then close the dosing flow path (block 810). Next, open the excess return flow path for a excess return flow duration, then close the excess return flow path (block 840). Either simultaneously or sequentially to opening the excess return flow path, dose the dosed amount (block 810).
Cycle 2: open the dosing flow path to fill the dosing chamber; close the dosing flow path (block 810). Open the oversupply return flow path, close the oversupply return flow path (block 850). Either simultaneously or sequentially to opening the oversupply return flow path, dose the dosed amount (block 810).
Cycle 3: Open the dosing flow path to fill the dosing chamber; close the dosing flow path (block 810). Open the supply flow path, close the supply flow path (block 860). Either simultaneously or sequentially to opening the supply flow path, dose the dosed amount (block 810).

The three cycles may then be repeated for the duration of the build process. As an example, for a cycle time of 10 sec between repeated blocks 820, the dosing flow path may be opened for a duration of 5 sec for each layer at block 810. In addition, one of the blocks 840 and 860 and, where present, of block 850, may be applied for 4 sec each cycle and in an alternating fashion so that each block is applied every second layer, or every third layer where block 850 is present.

### Buffer Tank

In some of the Figures described herein, a common inlet flow path 130_IN into the refill pump 90A is shown. Instead, the refill pump may comprise multiple inlets to provide for individual flow paths into the refill pump. Individual inlets to the dosing pump for the buffer tank and the bypass chamber 430 are illustrated for example in FIG. 7B. Furthermore, the valves as illustrated may be provided in the form of 2, 3, or 4-way valves, having more than one inlet and one outlet on the pump inlet side, and more than one outlet on the pump outlet side. The valves may be one-directional or bi-directional valves, and/or they may be variable or simple ON/OFF valves. It has been found that for example butterfly valves may be adequately controlled in a variable position to tune the amount of build material flow through the various flow paths. The pumps may be operated continuously or be switched on only when one or more of a dosing flow path, excess return flow path, oversupply return flow path and supply flow path is caused to open.

FIG. 8 is a 3D view of an example of a buffer tank in the form of a cylindrical container 50 having an upper infeed 510 and a lower outlet 520. The top surface of the container 50 comprises a vent 530 comprising a filter mesh configured to release gas from the container while preventing build material to exit through the vent. The infeed 510 and outlet 520 are arranged at a tangential direction to the circumference of the container. When the pump 90 is operated, build material is transferred under pressure via infeed 510 into the container 50 at a tangential angle to the circumference, such that build material introduced into the container is transported in a circulating manner. The outlet is arranged such that the powder material circulates along the inner container walls is transported out of the container along the direction of circulation within the container. Any excess gas or air is released via the vent 530. Thus the pump action may be used to mix the build material transferred into the buffer tank 50 into the resident build material to create a homogeneous mixture, and to maintain the build material in a free flowing state before it is caused to flow through the outlet 520 towards the dosing chamber 410. Additionally, or instead, an agitator may be provided inside the buffer tank 50 so as to mix the build material and maintain it in a free flowing state.

FIGS. 9A to 9D are 3D illustrations of an implementation of a mixing buffer tank 50 of FIG. 8. FIG. 9A is a cut through along the axis of outer cylinder wall 550 of the buffer tank. Along the axis, a rotational shaft 570 supports a mixing device 580 arranged at the lower section of the buffer tank interior configured to lift the build material from the bottom of the tank and mix and agitate it to keep it in a free flowing, homogeneous state. The top section of the buffer tank comprises a partial inner wall 560, thus creating a double wall for the upper portion of the tank. The partial inner wall 560 provides an inlet corridor for buffer tank inlet 510 shown in more detail in FIG. 9B. As build material is pumped into the buffer tank at a tangential angle to the outer and inner walls and along the corridor, the generation of build material dust within the buffer tank 50 is reduced. This variant of the buffer tank may not require a filtered vent since the outlet is shielded from powder dust. The build material falls downwards towards the floor of the buffer tank and is mixed into the resident build material by rotating the mixing device 580, illustrated in a side view mounted on the rotational shaft 570 in FIG. 9C, and in a 3D view in FIG. 9D. The mixing device comprises lifting blades 582 extending along the radial direction from the shaft for lifting the build material off the floor of the buffer tank. Helical frame sections 584A and 584B fixed to the shaft 570 by horizontal struts 588 connect the lower portion with the lifting blades to an upper mixing portion comprising churning blades 586 that transport the lifted build material towards the shaft. The buffer tank 50 may thus be arranged to continuously mix the build material and to prevent the generation of dust due to filling build material through the inlet 510 with a build material pump.

The buffer tank may further comprise a fill level sensor that detects when a fill level has been reached. FIG. 9A illustrates a mechanical version of a fill level sensor 540 in which a paddle extends from a mechanical switch from an upper tank portion vertically downwards into the tank. The paddle is hinged at the switching portion such that when the build material reaches the fill level, it pushes against the paddle and swings it from its vertical position to an angled position. This switches the switch so as to allow detection that the fill level has been reached. The controller coupled to the fill level sensor may close off the fill path into inlet 510 upon receiving a signal from the switch that the fill level has been reached.

The buffer tank may therefore be configured so as to mix build material by comprising mechanical stirring means and/or comprising an inlet and outlet arranged such that when the controller causes build material to flow into the buffer tank, the build material is mixed by the compressed gas pressure of the pump. This may further keep the build material in a fluidised state. The inlet into the buffer tank may be arranged to cause a vortical flow inside the buffer tank such that the bursts of gas and build material from the pump may be introduced into the buffer tank such that mixing the added build material into the existing build material inside the buffer tank may be achieved purely by the action of the pump, and such that step (e) may comprise operating the build material pump so as to mix the build material in the buffer tank. The buffer tank may comprise a fill level sensor configured to detect a fill level of build material inside the buffer tank, and wherein the controller is configured to open and shut the supply flow path based on the detected level of build material inside the buffer tank. The controller 100 may be configured to control the components of the material supply systems described herein so as to carry out the method and its variants described herein. Furthermore, the buffer tank may be configured to be heated by, for example, conductive heat foils arranged around the outer walls and/or by being configured to allow heated gas to enter, for example by percolating heated gas through the build material from the bottom of the buffer tank.

### Single Pump Systems

The build material supply system 10 and its variants described herein are improvements over single pump arrangements. Single pump arrangements will now be described which serve as background to the invention disclosed herein.

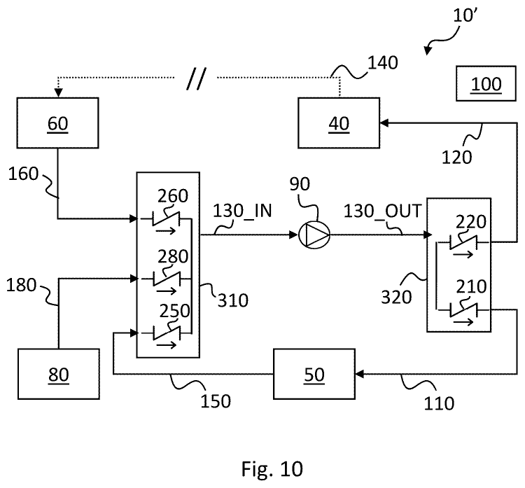

FIG. 10 is a block chart illustrating the flow paths for a single pump material supply system 10′ that is an alternative of the build material supply system 10 of FIG. 1B. The alternative build material supply system 10′ of FIG. 10 comprises the dosing device 40, the buffer tank 50, the excess return chamber 60, the supply tank 80 and the controller 100 similar as in the implementations according to the present invention. A single build material pump 90 is provided for transporting build material within the build material supply system 10. To control the flow of build material through the build material supply system 10, an inlet of the pump 90 is coupled to the supply tank 80 via a first valve 280, to the excess return chamber 60 via a second valve 260, and to the buffer tank 50 via a third valve 250. An outlet of the build material pump 90 is coupled to the buffer tank 50 via a fourth valve 210 and to an inlet of the dosing device 40 via a fifth valve 220. The controller 100 is coupled to the build material pump 90 and to the first, second, third, fourth and fifth valves.

To pump excess return build material along the excess return flow path 160, 110 from the excess return chamber 60 through the pump 90 and into the buffer tank 50, the controller is configured to: (a) shut off the dosing flow path 150, 120 from the buffer tank 50 through the pump 90 to the dosing chamber 40, by controlling the third valve 250 and the fifth valve 220 to close, (b) optionally, shut off the supply flow path 180, 110 from the supply tank 80 through the pump 90 to the buffer tank 50 by controlling the first valve 280 to close; (c) open the excess return flow path by controlling the second valve 260 and the fourth valve 210 to open, and (d) control the pump 90 to operate.

To allow fresh build material to flow along the supply flow path 180, 110, the controller 100 is configured to: control the third valve 250 and fifth valve 220 to close to shut off the dosing flow path 150, 120; to control the first valve 280 and the fourth valve 210 to open; and to control the pump to operate. To allow build material to flow along the dosing flow path, the controller 100 is configured to control the first valve 280, the second valve 260 and the fourth valve 210 to close so as to shut off the supply flow path 180, 110 and the excess return flow path 160, 110; to control the third valve 250 and the fifth valve 220 to open; and to control the pump 90 to operate.

In this way, for a single pump supply system, the amount of fresh build material transported into the buffer tank 50 compared to the excess amount of build material transported into the buffer tank 50 may be controlled. Furthermore, it may be ensured that the build material in the buffer tank 50 is replenished with fresh material to replace the layer amount removed from the build material supply system 10′ to form a layer. The single pump system therefore necessitates the use of five valves. Operation of the valves may cause undesirable delays in switching between dosing flow path and the excess return flow path and supply flow path, which risks underfeeding the dosing device and may cause formation of incomplete layers, leading to failure of the build process.

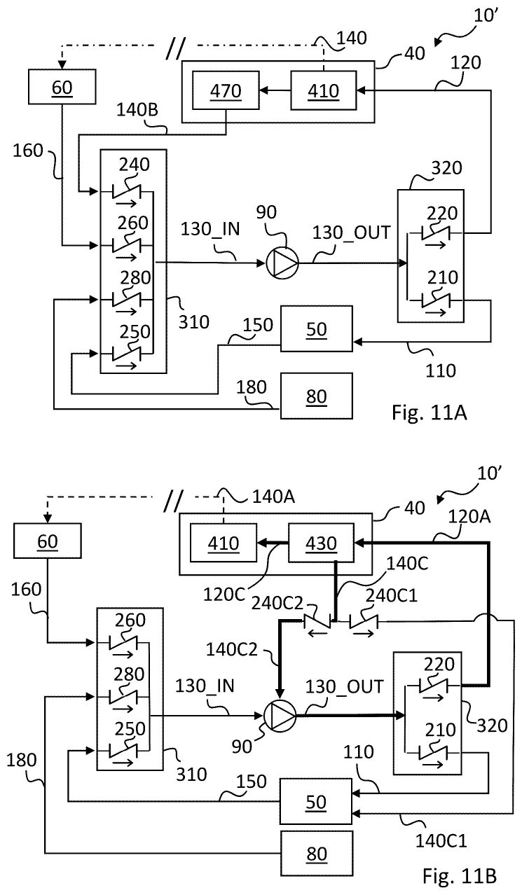

Single pump flow paths for the build material supply system 10′ further comprising an overflow return of FIG. 5B and a bypass return of FIG. 7B are shown in FIGS. 11A and 11B respectively, in which equivalent components are labelled the same. FIG. 11A is a variant of FIG. 10 in which the dosing device 40 comprises the dosing chamber 410 and an overflow. The overflow chamber 470 is coupled to the pump 90 via an overflow valve 470. This adds a further inlet valve to the pump, so that the inlet into the pump comprises at least four valves that need to be controlled to adequately control the build material flow into the buffer tank 50. Regarding the variant illustrated in FIG. 11B, a variant of FIG. 10 in which the dosing device 40 comprises the bypass chamber 430 and dosing chamber 410. The bypass outlet is coupled to the buffer tank 50 via a bypass direct return valve 240C1 which may be controlled to control the flow of build material from the bypass chamber to the buffer tank. An optional bypass recirculation flow path may be provided by further coupling the bypass outlet to further valve, recirculation valve 240C2, to the pump 90. Thus the pump 90 may comprise four outlet valves in this single pump alternative. The sequential operation of flow paths requiring sequential opening and closing of the valves may cause further delays to opening the dosing flow path in a timely manner to ensure sufficient build material is transported to the dosing chamber 410. FIG. 10 and FIGS. 11A and 11B serve to illustrate the advantages of the improved build material supply system 10 comprising two pumps according to the invention disclosed herein, in which the second pump replaces some of the valves required in the single pump system and ensures an independent control over the dosing flow path. This reduces or prevents the risk of short feeding the dosing chamber and thus of forming incomplete layers.

The dual pump build material supply system 10 according to the invention and its variants disclosed herein and their method of operation were found to allow a reliable supply of mixed build material of substantially stable homogenous consistency to the dosing device 40. This may be achieved by configuring the supply system such that a dosing pump 90B delivers a steady flow of build material to the dosing device while a refill pump 90A ensures transporting excess return build material and fresh build material, and, where present, to overflow build material, at a substantially constant ratio of material amounts to the buffer tank 50.

1. A build material supply system for an apparatus for the layerwise manufacture of 3D objects from build material, the build material supply system comprising:
a dosing device configured to supply a dosed amount of build material to a work surface of the apparatus, the dosed amount comprising a layer amount and an excess amount surplus to forming the layer;
a buffer tank configured to mix build material for supplying to the dosing device;
an excess return chamber for receiving excess build material from a distribution device;
a supply tank for holding fresh build material;
a first pump and a second pump for transporting build material within the build material supply system; and
a controller;
wherein an inlet of the first pump is coupled to the supply tank via a first valve and to the excess return chamber, and an outlet of the first pump is coupled to an inlet of the buffer tank;
wherein an inlet of the second pump is coupled to an outlet of the buffer tank and an outlet of the second pump is coupled to an inlet of the dosing device;
wherein the controller is coupled to the first pump, the second pump and the first valve, and, to control the amount of fresh build material compared to the excess amount of build material transported into the buffer tank, the controller is configured to:
control the first valve to at least partially open and the first pump to operate, to allow build material to flow along a supply flow path from the supply tank through the first pump and into the buffer tank;
optionally, control the first valve to at least partially close and the first pump to operate, to allow build material to flow along an excess return flow path from the excess return chamber through the first pump and into the buffer tank;
control the first valve to close, the first pump to stop operating, and the second pump to operate, to allow build material to flow along a dosing flow path from the buffer tank through the second pump and into the dosing device.

2. The build material supply system of claim 1, wherein the excess return chamber is coupled to the first pump via a second valve and the controller is coupled to the second valve, wherein to allow build material to flow along the supply flow path, the controller is configured to control the first valve to open, the second valve to close and the first pump to operate; and, to allow build material to flow along the excess return flow path, the controller is configured to control the first valve to close, the second valve to open and the first pump to operate.

3. The build material supply system of claim 1, wherein the dosing device comprises a dosing chamber coupled to the outlet of the second pump and configured to receive build material from the buffer tank via the second pump; the dosing device further comprising an overflow chamber, wherein the overflow chamber is coupled to the dosing chamber and configured to receive an oversupply amount of build material from the dosing chamber when the build material in the dosing chamber reaches a predefined level; wherein the overflow chamber is coupled to the inlet of the first pump via a third valve; wherein the controller is coupled to the third valve and configured to control the first valve to close and the third valve to open, and the first pump to operate, to allow oversupplied build material to flow along an oversupply return flow path from the overflow chamber through the first pump to the buffer tank.

4. The build material supply system of claim 3, wherein the excess return chamber is coupled to the first pump via a second valve and the controller is coupled to the second valve, wherein to allow build material to flow along the supply flow path, the controller is configured to control the first valve to open, the second valve to close and the first pump to operate; and, to allow build material to flow along the excess return flow path, the controller is configured to control the first valve to close, the second valve to open and the first pump to operate; and wherein, to allow oversupplied build material to flow along the oversupply return flow path, the controller is further configured to control the second valve to close.

5. The build material supply system of claim 1, wherein the controller is configured to prioritise the flow of build material into the buffer tank while causing the first pump to operate by applying the order of: firstly, allowing excess build material to flow along the excess return path by controlling the first valve to be at least partially closed; secondly, where present, allowing oversupply build material to flow along the oversupply return path by controlling the first and, where present, second valves to be at least partially closed and the third valve to be open; thirdly, allowing fresh build material to flow along the supply flow path by controlling the first valve to be open and controlling the third, and where present the second, valve to be closed.

6. The build material supply system of claim 1, wherein the dosing device comprises a dosing chamber, and a bypass chamber having an inlet and a bypass outlet at either end of an intermediate section, the intermediate section comprising one or more intermediate outlets, wherein the bypass inlet is coupled to the outlet of the second pump and the bypass outlet is coupled to the inlet of the buffer tank, and wherein the dosing chamber comprises one or more dosing chamber inlets configured to receive build material from the bypass chamber and coupled to the one or more intermediate outlets to form one or more intermediate flow paths; such that when the controller controls the second pump to operate, build material is caused to flow along the dosing flow path from the buffer tank through the second pump to the bypass chamber and along the one or more intermediate flow paths to the dosing chamber so as to supply build material from the buffer tank to the dosing chamber, and an oversupply of build material is caused to flow along a direct oversupply return flow path from the bypass chamber to the buffer tank.

7. The build material supply system of claim 6, wherein the bypass outlet is coupled to the inlet of the buffer tank via a third valve, wherein the controller is coupled to the third valve; wherein, to allow oversupply build material to flow along a direct oversupply return flow path, the controller is further configured to control the third valve to open when controlling the second pump to operate; and wherein to allow build material to flow along the dosing flow path, the controller is further configured to control the the third valve to close when controlling the first pump to operate.

8. The build material supply system of claim 7, wherein the bypass outlet is further coupled to the inlet of the second pump via a fourth valve, wherein the controller is coupled to the fourth valve; wherein the controller is configured to, in that order:
(i) allow build material to flow along the dosing flow path, and oversupply build material to return along the direct oversupply return flow path from the bypass chamber direct to the buffer tank, by controlling the fourth valve to close and the third valve to open, the second 1 pump to operate; and optionally controlling the first, and where present the second, valve to close;
(ii) to allow build material to circulate from the bypass chamber through the pump and back to the bypass chamber so as to reuse the oversupply amount of build material to fill the dosing chamber, controlling the third valve to close, the fourth valve to open and the second pump to operate;
(iii) the fourth valve to close and the first to operate, and:
allow excess build material to flow along the excess return path, by controlling, where present, the second valve to open, and by controlling the first valve to close; and
allow fresh build material to flow along the supply flow path, by controlling the first valve to open; and optionally, where present, controlling the second valve to close.

9. The build material supply system of claim 1, wherein the controller is configured to control the first valve to be open and the first pump to operate to allow build material to flow along the supply path simultaneously with excess build material flowing along the excess return flow path.

10. The build material supply system of claim 9, wherein the dosing device comprises a dosing chamber coupled to the outlet of the second pump and configured to receive build material from the buffer tank via the second pump; the dosing device further comprising an overflow chamber, wherein the overflow chamber is coupled to the dosing chamber and configured to receive an oversupply amount of build material from the dosing chamber when the build material in the dosing chamber reaches a predefined level; wherein the overflow chamber is coupled to the inlet of the first pump via a third valve; wherein the controller is coupled to the third valve and configured to control the first valve to close and the third valve to open, and the first pump to operate, to allow oversupplied build material to flow along an oversupply return flow path from the overflow chamber through the first pump to the buffer tank, and wherein the controller further controls the third valve to open to allow oversupply build material to flow from the overflow chamber into the buffer tank simultaneously with the excess build material and fresh build material.

11. (canceled)

12. (canceled)

13. (canceled)

14. The build material supply system of claim 1, wherein the buffer tank comprises a fill level sensor configured to detect a fill level of build material inside the buffer tank, and wherein the controller is configured to open and shut the supply flow path based on the detected level of build material inside the buffer tank.

15. The build material supply system of claim 1, wherein the controller is configured to cause the second pump to stop operating before controlling the first pump to operate, and to cause the first pump to stop operating before controlling the second pump to operate.

16. A method of transporting build material through a build material supply system for an apparatus for the layerwise manufacture of 3D objects from build material, the build material supply system comprising a first and second pump, the method comprising:
(a) opening a dosing flow path from a buffer tank to a dosing device, and operating the second pump, to transport build material from the buffer tank to the dosing device;
(b) dosing a dosed amount of build material to a work surface of an apparatus, the dosed amount comprising a layer amount for forming a layer and an excess amount surplus to forming a layer;
(c) receiving excess build material within an excess return chamber;
(d) opening an excess return flow path and operating the first pump to return excess build material from the excess return chamber to the buffer tank;
(e) opening a supply flow path from a supply tank to the buffer tank, and operating the first pump to transport build material from the supply tank to the buffer tank, until either a predetermined fill duration has passed or upon detecting that the level of build material in the buffer tank has reached a predefined fill level; and
(f) mixing the excess amount with the build material in the buffer tank.

17. The method of claim 16, wherein step (a) is repeated between steps (d) and (e).

18. The method of claim 16, wherein step (a) comprises not operating the first material pump.

19. The method of claim 16, wherein step (d) and/or step (e) are carried out at least partially during step (b) and/or (c).

20. The method of claim 16, wherein step (d) and/or step (e) comprise not operating the second material pump.

21. The method of claim 16, wherein step (f) is carried out before each step (a).

22. The method of claim 16, wherein:
excess build material at step (d) is returned to the buffer tank before transporting fresh build material from the supply tank to the buffer tank at step (e) and a plurality repeats of steps (d) and (e) are applied such that a ratio of the amount of excess build material and fresh build material flowing into the buffer tank remains substantially constant over the plurality of repeats; and/or
the steps (d) and (e) are applied simultaneously and comprise applying different flow resistances to the respective flow paths such that a ratio of the amount of excess build material and fresh build material flowing into the buffer tank remains substantially constant over a plurality of repeats of steps (d) and (e).

23. (canceled)

24. The method of claim 16, wherein step (e) comprises sensing a fill level of build material within the buffer tank and applying step (e) until detecting that the level of build material in the buffer tank has reached a predefined fill level.
